(19) United States
(12) Patent Application Publication
(10) Pub. No.: US 2009/0063179 A1
(43) Pub. Date: Mar. 5, 2009

(54) SYSTEM AND METHOD FOR CUSTOMIZING USER INTERFACES OF ELECTRONIC DEVICES

(75) Inventor: TZU-HAO HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/133,385

(22) Filed: Jun. 5, 2008

(30) Foreign Application Priority Data
Aug. 31, 2007 (CN) 200710201560.3

(51) Int. Cl. G06F 9/44; G06Q 30/00

(52) U.S. Cl. 705/1; 717/173

(57) ABSTRACT

An exemplary method for customizing user interfaces of electronic devices includes steps of: receiving a request for customizing a user interface from a terminal device; acquiring configuration data on a current user interface of the terminal device; analyzing the configuration data; adjusting functional groups; programming a customized user interface software; programming an installation software for installing the customized user interface software; packing the customized user interface software and the installation software in a software package; uploading the software package to a designated location; downloading the software package to the terminal device; and installing the customized user interface software in the terminal device by executing the installation software.

### BACKGROUND

1. Field of the Invention

The present invention relates to systems and methods for managing user interfaces of electronic devices, and particularly to a system and method for customizing user interfaces of electronic devices.

2. Description of Related Art

With the continuing development in technology, more and more functionality are being added to electronic devices. Functionality may be added to a mobile phone whereby the mobile phone could be used as a Personal Digital Assistant (PDA) or an MP3 player. Similarly, PDAs or MP3 players may incorporate mobile communication functionality. Each of the electronic devices provides a user interface for performing various kinds of operations by users, so as to communicate information between the users and the electronic devices. Generally, depending on the make/model, electronic devices have different user interfaces, each user interface represents special classifications of functional groups.

For example, if a user, through use, becomes familiar with a particular user interface designed by a first manufacturer (.e.g., Nokia®), the user may not easily adapt to other user interfaces from other manufacturers (e.g., Motorola®, Samsung®, etc). Thus users of the electronic devices designed by one manufacturer may be unwilling to change their personal habits to purchase or use other electronic devices produced by other manufacturers. However, if other manufacturers develops newer electronic devices having more functionality/applications, but with different user interfaces, than the current electronic devices, the additional functionality/applications of the newer electronic devices may not persuade the users, of the current electronic devices, to switch to the newer electronic devices because the users may not want to use an electronic device with an unfamiliar user interface.

Accordingly, what is needed is a system and method for customizing user interfaces of electronic devices, the customized user interfaces is according to user demands, so that the users can use a familiar or favorite user interface in different electronic devices.

### SUMMARY

An exemplary method for customizing user interfaces of electronic devices includes following steps of: receiving a request for customizing a user interface from a terminal device; acquiring configuration data on a current user interface of the terminal device, the configuration data comprising a plurality of functional groups; analyzing the configuration data on the current user interface; adjusting the functional groups according to the request; programming a customized user interface software; programming an installation software for installing the customized user interface software in the terminal device; packing the customized user interface software and the installation software in a software package; uploading the software package to a designated location; downloading the software package to the terminal device from the designated location; and installing the customized user interface software in the terminal device by executing the installation software.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a schematic diagram illustrating a hardware configuration of a system for customizing user interfaces of electronic devices (hereinafter, “the system”) in accordance with an exemplary embodiment.

FIG. 2 is a functional block diagram of the system of FIG. 1.

FIG. 3 is a schematic diagram of a current user interface of a terminal device of FIG. 1.

FIG. 4 is a schematic diagram of a customized user interface programmed by the system of FIG. 1.

FIG. 5 is a flow chart illustrating a method for customizing user interfaces of electronic devices in accordance with an exemplary embodiment.

FIG. 6 is a flow chart illustrating a method for customizing user interfaces of electronic devices in accordance with another exemplary embodiment.

### DETAILED DESCRIPTION OF THE EMBODIMENTS

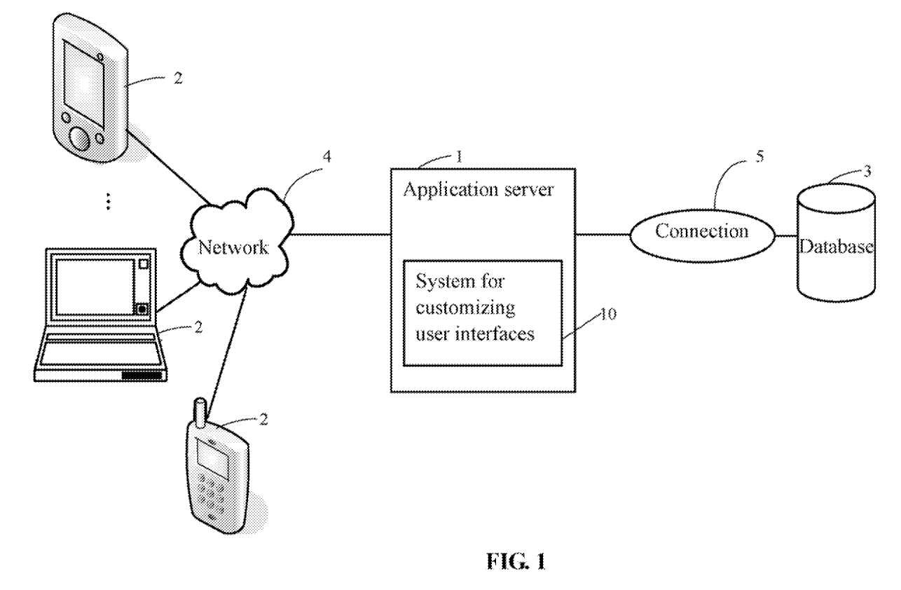

FIG. 1 is a schematic diagram illustrating a hardware configuration of a system for customizing user interfaces of electronic devices (hereinafter, “the system”) in accordance with an exemplary embodiment. The system 10 is installed and implemented by an application server 1, which is connected with a plurality of terminal devices 2 through a network 4. The terminal devices 2 may be different kinds of electronic devices, such as mobile phones, notebooks, Palms, personal digital assistants (PDAs), and so on. In the exemplary embodiment, the terminal devices 2 are mobile phones, which may communicate with the application server 1 through the network 4. Each of the terminal devices 2 provides an interactive user interface for performing various kinds of operations, such as editing/sending/receiving messages, playing games, viewing files such as emails, and so on.

The network 4 may be an intranet, the Internet, or any other suitable type of communication network. In the exemplary embodiment, the network 4 is the Global System for Mobile communications (GSM) network.

The application server 1 is electronically connected with the database 3 via a connection 5. The database 3 is configured for storing various kinds of data processed or generated during the customizing process. The database 3 may be a hard disk (not shown in FIG. 1) located in the application server 1, or a storage device located outside of the application server 1, such as a compact flash card (CFC), an extreme digital card (XDC), and a trans flash card (TFC), etc. The connection 5 is a kind of database connectivity, such as an open database connectivity (ODBC) or a java database connectivity (JDBC).

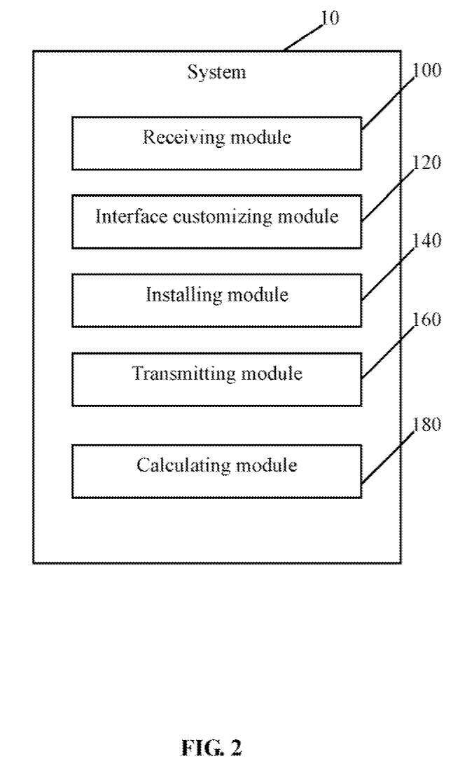

FIG. 2 is a functional block diagram of the system 10 of FIG. 1. In the exemplary embodiment, the system 10 typically includes a receiving module 100, an interface customizing module 120, an installing module 140, and a transmitting module 160.

The receiving module 100 is configured for receiving a request from one of the terminal devices 2. In the exemplary embodiment, the request particularly relates to customize a user interface for replacing a current user interface of the terminal device 2. Generally, each of the terminal devices 2 provides a user interface for operating functions of the terminal devices 2. The terminal devices 2 of different manufacturers have different user interface configurations. People is accustomed to a first user interface provided by a first manufacturer (i.e., Nokia®) may not easily adapt to a user interface configurations of a secondary manufacturer (i.e., Motorola®). The secondary manufacturer may provide a service of reconfiguring the user interface for the people, who is accustomed to the first user interface, by utilizing the system 10. For simplicity, one of the terminal devices 2 (hereinafter, “the terminal device 2”) is introduced in the following description.

In the exemplary embodiment, the application server 1 may belong to a manufacturer for satisfying user demand to customize a user interface for the terminal device 2. For example, the user has a mobile phone of manufacturer A, however, the mobile phone has an unaccustomed user interface. Thus a request may be sent from the mobile phone to an application server 1, which belongs to the manufacturer A, to reconfigure the unaccustomed user interface of the mobile phone to an accustomed user interface. Then the system 1 in the application server 1 processes the request. Moreover, the user may request for customizing a personalized user interface in accordance with the user preference.

The receiving module 100 is further configured for acquiring configuration data on a current user interface of the terminal device 2. The configuration data on the current user interface may include, but not limited to, the manufacturer and the type of the terminal device 2, data on the operating system (OS) of the terminal device 2, a plurality of functional groups provided by the current user interface, a plurality of options and corresponding functions included in each of the functional groups, and hardware configuration of the terminal device 2, etc.

The interface customizing module 120 is configured for analyzing the request and the configuration data on the current user interface, adjusting the functional groups according to the request, and programming a customized user interface software. Analysis of the configuration data on the current user interface may include, but not limited to: analyzing a number of the functional groups, an arrangement sequence of the functional groups, the options included in each of the functional groups, and the functions corresponding to the options, and analyzing hardware configuration of the terminal device 2 so as to install the customized user interface software in the terminal device 2.

Analysis of the request may include, but not limited to: analyzing the functional groups that the user needed and the arrangement sequence of the functional groups, analyzing the options and corresponding functions included in each of the functional groups, and further analyzing other related information.

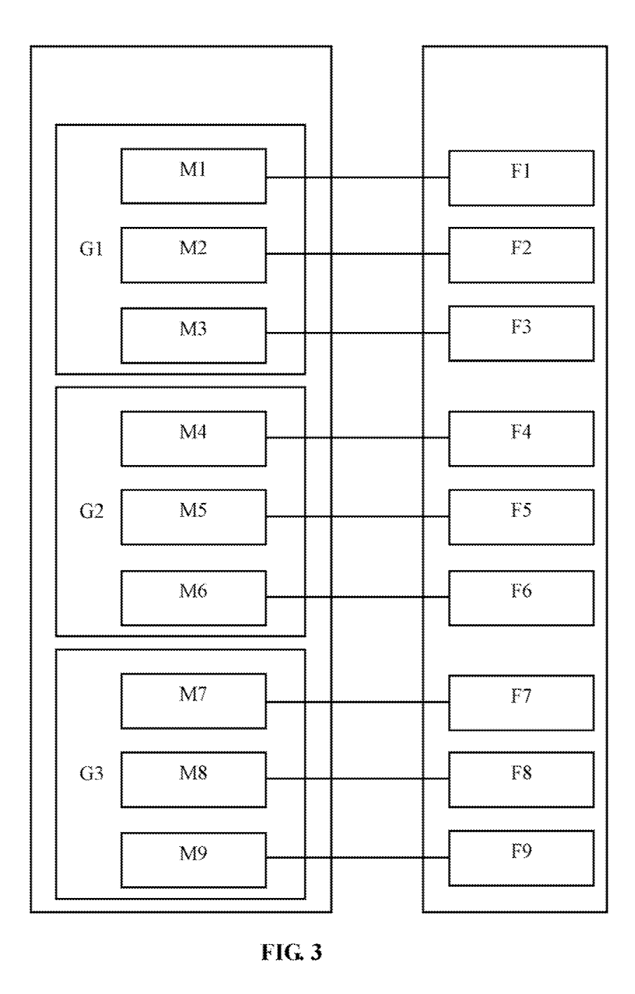

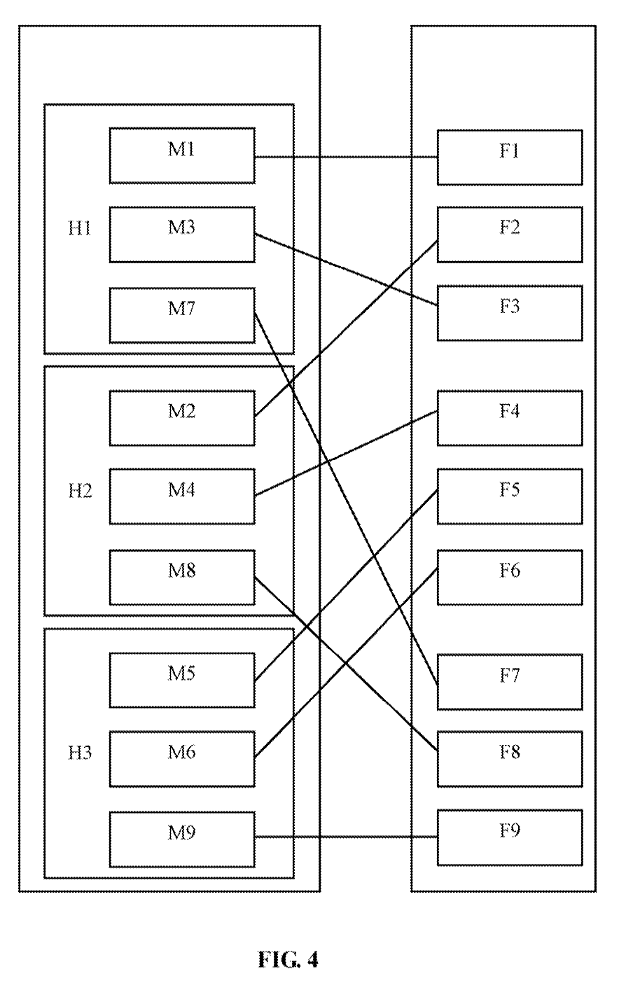

Adjustments of the functional groups (described below in relation to FIG. 3 and FIG. 4) may include, but not limited to: adjusting the arrangement sequence of the functional groups, adjusting the number of the functional groups and the options included in each of the functional groups.

The installing module 140 is configured for programming an installation software for installing the customized user interface software in the terminal device 2. The installation software is used for copying the current user interface into a storage of the terminal device 2, uninstalling the current user interface from the terminal device 2, and prompting the user to install the customized user interface software in the terminal device 2. The installing module 140 is further configured for packing the customized user interface software and the installation software in a software package.

The transmitting module 160 is configured for uploading the software package to a designated location for being downloaded by the terminal device 2, and storing the software package into the database 3. For example, the designated location may be a location provided by a file transfer protocol (FTP) server, or a location in the database 3.

The terminal device 2 downloads the software package from the designated location, unpacks the software package, and executes the installation software to install the customized user interface software in the terminal device 2.

The system 10 may further include an calculating module 180, which is configured for calculating customized fees according to the request from the user, setting distribution objects and a distribution ratio, charging the customized fees, and distributing the customized fees to the distribution objects according to the distribution ratio. For example, the distribution objects may include the manufacturer, a developer of the system 10, and a manager of a Web site that provides a storage space for storing the software package to be downloaded by the user, etc. The calculating module 180 may charge the customized fees via internet banking.

In other embodiments, programmers may program various kinds of user interfaces via the interface customizing module 120, and put the user interfaces to the designated location for being viewed, selected or purchased by customers.

FIG. 3 is a schematic diagram of a current user interface of the terminal device 2 of FIG. 1. The current user interface of the terminal device 2 has three functional groups G1, G2 and G3. The functional group G1 has three options M1, M2 and M3 corresponding to three functions F1, F2 and F3 respectively. The functional group G2 has three options M4, M5 and M6 corresponding to three functions F4, F5 and F6 respectively. The functional group G3 has three options M7, M8 and M9 corresponding to three functions F7, F8 and F9 respectively. As shown in FIG. 3, each option corresponds to a kind of function.

FIG. 4 is a schematic diagram of a customized user interface programmed by the system 10 of FIG. 1. The customized user interface programmed by the interface customizing module 120 has three functional groups H1, H2 and H3. The functional group H1 has three options M1, M3 and M7 corresponding to three functions F1, F3 and F7 respectively. The functional group H2 has three options M2, M4 and M8 corresponding to three functions F2, F4 and F8 respectively. The functional group H3 has three options M5, M6 and M9 corresponding to three functions F5, F6 and F9 respectively. Comparing FIG. 3 with FIG. 4, the functional groups in FIG. 3 are regrouped, that is, the options in each of the functional groups in FIG. 3 are adjusted while relationships between the options and the functions are not changed.

In other embodiments, all of the functional groups, the options and the functions may be newly added, removed, or modified, and the relationships between the options and the functions may be changed, so as to satisfy with the user to customize the personal user interface.

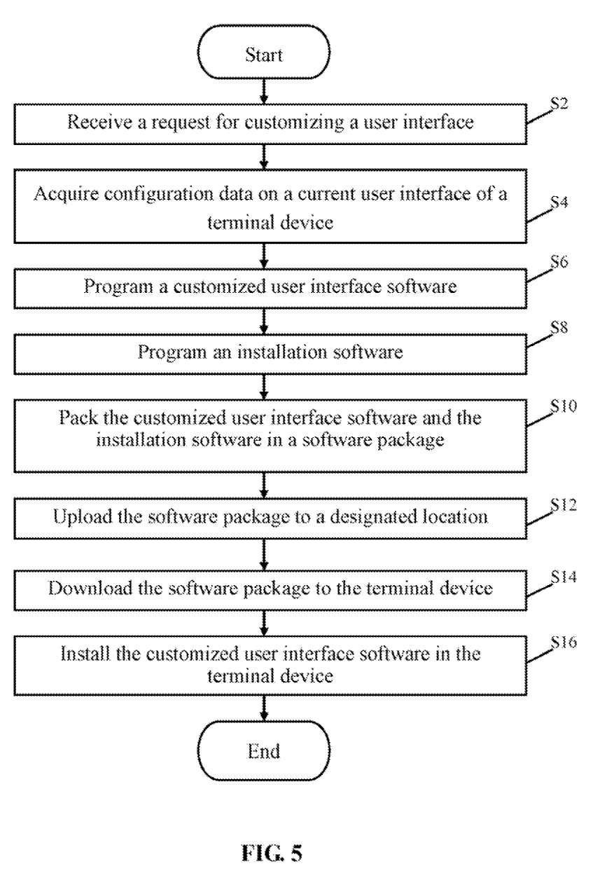

FIG. 5 is a flow chart illustrating a method for customizing user interfaces in accordance with an exemplary embodiment. In step S2, the receiving module 100 receives a request for customizing a user interface from one of the terminal devices 2.

In step S4, the receiving module 100 acquires configuration data on the current user interface of the terminal device 2. The configuration data on the current user interface may include, but not limited to, the manufacturer and the type of the terminal device 2, data on the OS of the terminal device 2, a plurality of functional groups provided by the current user interface, a plurality of options and corresponding functions included in each of the functional groups, and the hardware configuration of the terminal device 2, etc.

In step S6, the interface customizing module 120 analyzes the request and the configuration data on the current user interface, adjusts the functional groups according to the request, and programs the customized user interface software.

In step S8, the installing module 140 programs the installation software for installing the customized user interface software in the terminal device 2. The installation software is used for copying the current user interface into a storage of the terminal device 2, uninstalling the current user interface from the terminal device 2, and prompting the user to install the customized user interface software in the terminal device 2.

In step S10, the installing module 140 packs the customized user interface software and the installation software in a software package.

In step S12, the transmitting module 160 uploads the software package to the designated location, and storing the software package into the database 3. For example, the designated location may be a location provided by a file transfer protocol (FTP) server.

In step S14, the terminal device 2 downloads the software package from the designated location, and unpacks the software package. In step S16, the terminal device 2 executes the installation software to install the customized user interface software in the terminal device 2.

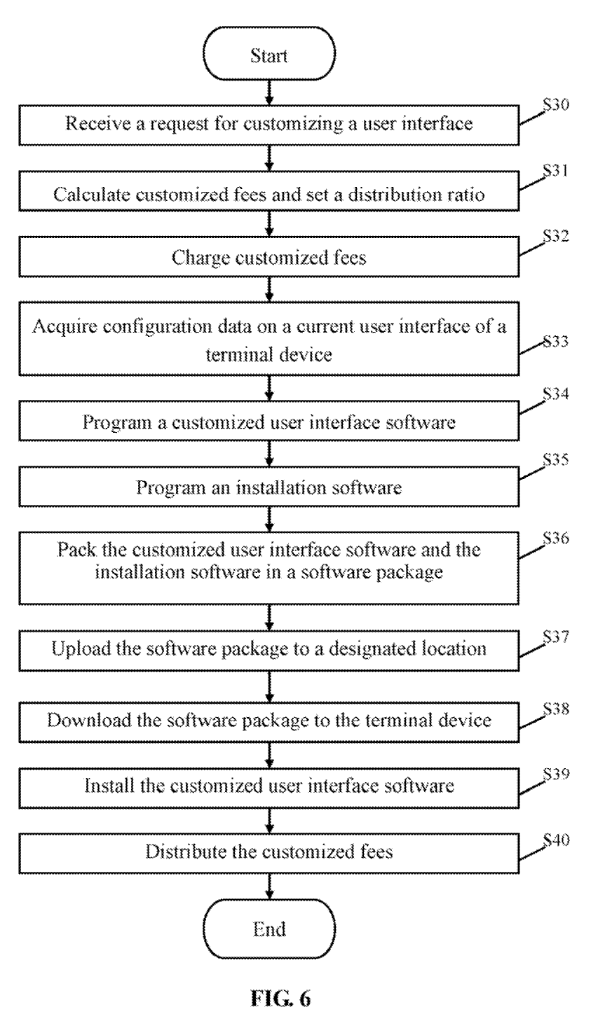

FIG. 6 is a flow chart illustrating a method for customizing user interfaces of electronic devices in accordance with another exemplary embodiment. In step S30, the receiving module 100 receives a request for customizing a user interface from one of the terminal devices 2.

In step S31, the calculating module 180 calculates the customized fees according to the request, and sets the distribution objects and the distribution ratio. In step S32, the calculating module 180 charges the customized fees.

In step S33, the receiving module 100 acquires configuration data on the current user interface of the terminal device 2. In step S34, the interface customizing module 120 analyzes the request and the configuration data on the current user interface, adjusts the functional groups according to the request, and programs the customized user interface software.

In step S35, the installing module 140 programs the installation software for installing the customized user interface software in the terminal device 2. The installation software is used for copying the current user interface into a storage of the terminal device 2, uninstalling the current user interface from the terminal device 2, and prompting the user to install the customized user interface software in the terminal device 2.

In step S36, the installing module 140 packs the customized user interface software and the installation software in a software package. In step S37, the transmitting module 160 uploads the software package to the designated location, and storing the software package into the database 3.

In step S38, the terminal device 2 downloads the software package from the designated location, and unpacks the software package. In step S39, the terminal device 2 executes the installation software to install the customized user interface software. In step S40, the calculating module 180 distributes the customized fees to the distribution objects according to the distribution ratio.

It should be emphasized that the above-described embodiments, particularly, any “exemplary” embodiments, are merely possible examples of implementations, and set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s), and the present invention is protected by the following claims.

What is claimed is:

1. A system for customizing user interfaces of electronic devices, the system being installed in an application server connected with a plurality of terminal devices, the system comprising:
a receiving module configured for receiving a request for customizing a user interface from one of the terminal devices, and acquiring configuration data on a current user interface of the terminal device, the configuration data comprising a plurality of functional groups;
an interface customizing module configured for analyzing the configuration data on the current user interface, adjusting the functional groups according to the request, and programming a customized user interface software;
an installing module configured for programming an installation software for installing the customized user interface software in the terminal device, and packing the customized user interface software and the installation software in a software package; and
a transmitting module configured for uploading the software package to a designated location for being downloaded by the terminal device.

2. The system as claimed in claim 1, wherein the terminal device is configured for downloading the software package from the designated location, unpacking the software package, and executing the installation software to install the customized user interface software in the terminal device.

3. The system as claimed in claim 1, wherein the installation software is further used for copying the current user interface into a storage of the terminal device, and uninstalling the current user interface from the terminal device.

4. The system as claimed in claim 1, wherein each of the functional groups comprises a plurality of options and corresponding functions.

5. The system as claimed in claim 4, wherein the interface customizing module analyzes the configuration data on the current user interface by analyzing a number of the functional groups, an arrangement sequence of the functional groups, the options included in each of the functional groups, and the functions corresponding to the options, and analyzing hardware configuration of the terminal device to install the customized user interface software in the terminal device.

6. The system as claimed in claim 4, wherein the interface customizing module adjusts the functional groups of the current user interface by adjusting an arrangement sequence of the functional groups, adjusting a number of the functional groups and the options included in each of the functional groups.

7. The system as claimed in claim 1, further comprising an calculating module configured for calculating customized fees according to the request, and charging the customized fees.

8. The system as claimed in claim 7, wherein the calculating module is further configured for setting distribution objects and a distribution ratio, and distributing the customized fees to the distribution objects according to the distribution ratio.

9. A computer-implemented method for customizing user interfaces of electronic devices, the method comprising:
receiving a request for customizing a user interface from a terminal device;
acquiring configuration data on a current user interface of the terminal device, the configuration data comprising a plurality of functional groups;
analyzing the configuration data on the current user interface;
adjusting the functional groups according to the request;
programming a customized user interface software;
programming an installation software for installing the customized user interface software in the terminal device;
packing the customized user interface software and the installation software in a software package;
uploading the software package to a designated location;
downloading the software package to the terminal device from the designated location; and
installing the customized user interface software in the terminal device by executing the installation software.

10. The method according to claim 9, wherein the installing step comprises:
copying the current user interface into a storage of the terminal device; and
uninstalling the current user interface from the terminal device.

11. The method according to claim 9, wherein each of the functional groups comprises a plurality of options and corresponding functions.

12. The method according to claim 11, wherein the analyzing step comprises:
analyzing a number of the functional groups;
analyzing an arrangement sequence of the functional groups;
analyzing the options included in each of the functional groups, and the functions corresponding to the options; and
analyzing hardware configuration of the terminal device to install the customized user interface software in the terminal device.

13. The method according to claim 11, wherein the adjusting step comprises:
adjusting an arrangement sequence of the functional groups;
adjusting a number of the functional groups; and
adjusting the options included in each of the functional groups.

14. The method according to claim 9, further comprising:
calculating customized fees according to the request;
setting distribution objects and a distribution ratio; and
charging the customized fees.

15. The method according to claim 14, further comprising:
distributing the customized fees to the distribution objects according to the distribution ratio.
